(19) United States
(12) Patent Application Publication
(10) Pub. No.: US 2013/0229156 A1
(43) Pub. Date: Sep. 5, 2013

(54) BATTERY MONITORING IN ELECTRIC VEHICLES, HYBRID ELECTRIC VEHICLES AND OTHER APPLICATIONS

(71) Applicants: Nigel Brandon, Surrey (GB); Paul Mitcheson, London (GB); Vladimir Yufit, London (GB); David Howey, London (GB); Gregory Offer, London (GB)

(72) Inventors: Nigel Brandon, Surrey (GB); Paul Mitcheson, London (GB); Vladimir Yufit, London (GB); David Howey, London (GB); Gregory Offer, London (GB)

(73) Assignee: IMPERIAL INNOVATIONS LIMITED, London (GB)

(21) Appl. No.: 13/819,305

(22) PCT Filed: Jul. 26, 2011
(86) PCT No.: PCT/GB11/01124

§ 371 Date: May 13, 2013

(30) Foreign Application Priority Data
Aug. 27, 2010 (GB) 1014384.0

(51) Int. Cl. H02J 7/00

(52) U.S. Cl. CPC H02J 7/0065
USPC 320/136

(57) ABSTRACT

A method for monitoring the condition of at least one cell of a battery, used in an electric or hybrid electric vehicle. The battery is connected to a power converter to supply electrical power to an electrical load. The method includes the steps of: controlling the power converter to vary the input impedance of the power converter to draw a varying current from the cell; sensing the voltage across the cell and the current drawn in response to varying the impedance of the power converter; calculating from the sensed voltage and current the complex impedance of the cell; and comparing the calculated complex impedance with information indicative of a correlation between (i) the complex impedance and (ii) information indicative of the condition of the cell, to give an indication of the condition of the cell. The varying current may be actively varied or passively varied.

### FIELD

This invention relates to a method of monitoring the condition of a least one cell of a battery, such as a battery pack. In some embodiments, this disclosure relates to battery monitoring in an electric or hybrid electric vehicle. In other embodiments, this disclosure relates to battery monitoring in other applications.

### BACKGROUND

Recent years have seen an increased demand for forms of transport that have a reduced impact on the surrounding environment and that are more economical to run. In particular, electric vehicles and hybrid electric vehicles, particularly in the form of passenger cars, are attracting increased attention as forms of transport that show promise in satisfying this demand.

Successful commercialisation of such vehicles has, so far, been limited by considerations relating to the batteries used in such applications. Of the various battery technologies currently used, lithium-ion based batteries are superior in terms of energy per unit mass and energy per unit volume, and so are attractive in vehicle applications where the mass and volume taken up by power-train components such as the battery may advantageously be minimised.

Regardless of the type of battery used, however, proper management of the battery is very important. This is true, for example, for Nickel-Metal Hydride (NiMH), Lead Acid batteries, Redox Flow batteries, and conceivably any electrochemical device that has cells.

Lithium-ion batteries, although superior in many respects, suffer from relatively high cost and are intolerant to being overcharged or over-discharged. Indeed, those with metal oxide cathodes may even explode if overcharged. It is especially difficult to allow for these characteristics where cells are connected in series and parallel to form battery packs that can supply the current and voltage needed in vehicle applications. This is because manufacturing variability results in different cells having different internal resistances, which can result in different cells having different states of charge (SOC), and hence slightly different voltages, after multiple charge-discharge cycles. This increases the likelihood of one of more of the cells being overcharged or over-discharged and in extreme cases the failure of individual cells. As already noted, such abuse of the battery can result in failure of the battery and would require the owner of the vehicle to replace the battery at high cost.

It will therefore be appreciated that proper management of batteries during use is vital to the commercial success of electric and hybrid electric vehicles.

In an attempt to solve this problem, existing electric and hybrid electric vehicles include battery management systems (BMS) that seek to monitor the SOC of the individual cells in the batteries used in such vehicles and so avoid overcharging or over-discharging. Such systems may also measure the state of health, state of life and other parameters of the cells; and may also aim to equalise state of charge of the cells.

In certain of these existing battery management systems, two methods are combined to achieve an estimate of SOC. In the first of these methods, the initial SOC of the cell is estimated by measuring the open circuit voltage (OCV) and then consulting a look-up table or using a mathematical function to give the SOC from the measured OCV. A look-up table is sometimes preferred as SOC is a complex function of the OCV. In carrying out this method to find the initial SOC, it is important that the OCV is measured only after the battery has been completely disconnected from a load for approximately 4 to 6 hours in order to stabilise the OCV of each cell. Secondly, and during operation, a method called “coulomb counting” is used to give a real-time estimate of the SOC. This involves direct current measurement of each cell and then integration of the cell current over time during cell charge and discharge to give the increase or decrease in charge. From the initial SOC and this increase or decrease in charge, the current SOC can be estimated. In some of these methods, the temperature of the cell and its self-discharge rate are also taken into account

Such existing battery management systems are problematic for several reasons:
As already mentioned, determining the initial SOC is time consuming.
Performing accurate coulomb counting during vehicle operation is not always possible and accuracy may decrease with time due to integration drift,
Initial SOC estimation based on OCV-SOC look-up tables can be less accurate with lithium-ion batteries having phosphate cathodes (such as LiFePo4 batteries) because the variation of OCV with SOC is much less prominent than is the case with batteries having metal oxide cathodes.

As mentioned above, without good battery monitoring, the commercial viability of electric and hybrid electric vehicles is reduced. Thus, there is a need for an improved arrangement for monitoring the condition of batteries in such applications.

These problems with existing battery monitoring systems are not confined to automotive applications. Instead almost any device that using rechargeable batteries would benefit from improved battery monitoring: many people will have experienced the frustration of using a mobile telephone with apparently a third of the possible charge remaining only to find that it discharges surprisingly quickly. Thus, there is also a need for improved battery monitoring in other applications.

### SUMMARY

According to a first aspect of this invention, there is provided a method of monitoring the condition of at least one cell of a battery connected to a power converter to supply electrical power to an electrical load, the method including the steps of:
a) controlling the power converter to vary the input impedance of the power converter so as to draw a varying current from the at least one cell;
b) sensing the voltage across the at least one cell and the current drawn therefrom in response to varying the impedance of the power converter;
c) calculating from the sensed voltage and current the complex impedance of the at least one cell; and
d) comparing the calculated complex impedance with information indicative of a correlation between (i) the complex impedance and (ii) information indicative of the condition of the at least one cell, to give an indication of the condition of the at least one cell.

Step (c) may comprise calculating from the sensed voltage and current the complex impedance of the at least one cell at different frequencies.

Thus, in more everyday terms, there is provided a method of using electrochemical impedance spectroscopy (EIS) to monitor the condition of a cell or battery in situ—i.e. when it is connected to the power electronics and useful load of the application which it is to power—by making use of the existing power electronics. This avoids the need for dedicated equipment to carry out the EIS and have avoids the added cost, size, weight and complexity of such dedicated equipment. Reducing cost, size, weight and complexity are important factors in the design and commercial success of both vehicles and smaller electrical devices.

EIS is a procedure sometimes used in a laboratory to obtain highly accurate measurements of an individual cell. It relies on using a large and expensive digital signal generator to draw a small sinusoidal AC current from the cell or apply small AC voltage across the cell terminals at different frequencies. By ascertaining the frequency response of the complex impedance of the cell using a frequency response analyser, vital information relating to the state of health and state of charge of the cell can be ascertained. In EIS, knowledge of the history of the cell is not required (in contrast with Coulomb counting) and so errors do not accumulate over time to reduce the accuracy of deductions as to the condition of the cell.

In embodiments of the invention, EIS is taken out of the laboratory and made to work in situ—that is, in applications in which cells are used to provide useful power to supply a load. Examples of this might be cells used in an electric or hybrid electric vehicle, or even cells used in a smaller device such as a hand-held mobile telephone or a portable computer. By unconventionally controlling the power converter such that its input impedance is varied, a varying current can be drawn from the cell and then sensed together with the voltage across the cell to allow the complex impedance of the cell to be calculated. The complex impedance at a known, sensed or calculated frequency or frequencies can then be used to ascertain the state of health and state of charge of the cell.

### [Power Converter-Related Features]

The power converter may comprise a DC to DC converter; it may comprise a DC to AC converter, such as an inverter. Step (a) of the method may comprise controlling the inverter to vary the input impedance of the inverter. The power converter may be in the form of a motor controller and the load may be a motor. This arrangement may be used as at least part of the drive-train of a vehicle, such as an electric vehicle or a hybrid electric vehicle. Step (a) of the method may comprise controlling an inverter of the motor controller to vary the input impedance of the inverter.

### Example Applications

The power converter may be a power converter for an electronic device, such as a portable electronic device, for example a mobile telephone, a portable computer or conceivably any other electronic device that can be powered by a rechargeable battery, or even by any other electrochemical device having cells. It is envisaged that embodiments of the invention may be used with, for example, Lithium Ion, Nickel-Metal Hydride (NiMH), Lead Acid and Redox Flow batteries; and also, conceivably, cellular telephone base-stations and off-grid power supplies such as those involving photovoltaic cells, a battery and an inverter. These are all just examples.

### [Varying Current]

The varying current may comprise a current drawn from the cell to usefully power the load. The varying current may not comprise a current drawn from the cell to usefully power to load.

The varying current may comprise a periodically varying current; it may comprise a ripple current; it may comprise a sinusoidal alternating current. The varying current may comprise a current with any waveform whatsoever, periodic or not. The varying current may vary by only a small amount. The amount of variation in the current may be sufficiently small such that a linear assumption of battery response is justified. The varying current may result in a battery voltage change of no more than between 5 and 20 mV per cell. The resulting battery voltage change may be no more than 10 mV per cell.

### [Active Approach]

Step (a) may comprise varying the input impedance of the power converter to vary the current drawn from the battery—that is to introduce a perturbation in that current—other than to supply a variation in the load demand. This may be considered an “active” approach.

### [Passive Approach]

Step (a) may comprise varying the input impedance of the power converter to vary the current drawn from the battery—that is to introduce a perturbation in that current—in order to supply a variation in the load demand. This may be considered an “passive” approach. Controlling the power converter in this way may allow the method to monitor the condition of the cell during normal control of the power converter to supply the load and without controlling the power converter specially to vary the impedance seen by the cell. Step (a) may comprise controlling the power converter in this way to accelerate or decelerate the motor. Thus, the arrangement may be used during normal operation of, for example, the car, with the varying current being the current demanded as a result of, for example, the driver varying a torque demand such as by varying the position of an accelerator.

### [Various Perturbation Methods]

The method may include carrying out the steps with a varying current of a first frequency and then repeating those steps with a varying current of a different frequency.

The steps may be repeated plural times, each time with a varying current of a different respective frequency. The steps may be repeated with different varying currents in the range of 10 mHz and 10 kHz. The range may be between 10 mHz and 500 Hz. The method may comprise carrying out the steps a varying current of a plurality of different frequencies simultaneously. The plurality of different frequencies may be in the ranges noted above. The varying current may be sinusoidally varying. This approach may be a feature of the active approach.

The method may comprise the varying current taking the form of a pseudo-random binary sequence, such as a maximal length sequence. This approach may be a feature of the active approach.

The varying current may vary other than periodically. Step (a) may comprise controlling the power converter to vary the impedance such that an arbitrary, optionally non-periodic, load is applied to the at least one cell, the varying current corresponding accordingly. Such arbitrary, optionally non-periodic, loads are termed “pulse” loads herein for convenience. Pulse loads may, for example, take the form of a square wave, a step, an impulse, a ramp, a saw tooth and so on. This approach may be a feature of the active and/or passive approach. When a feature of the passive approach, it will be understood that the pulse load is as a result of a sudden change in load demand, such as, for example, a user pressing the accelerator.

The voltage and current sensed in step (b) and used to calculate the complex impedance calculated in step (d) may be noise and/or other spectral content present as a result of normal operation.

### [Combinations and Alternatives]

The method may include controlling the power converter to draw a periodically varying current and also controlling the power converter to apply a pulse load variation. These may happen simultaneously; these may happen other than simultaneously. A periodically varying current may be used when the vehicle is stationary. A pulse load variation—such as, for example, any arbitrary non-periodic load variation such as might be applied as a result of a variation in torque demand requested as part of normal driving—may be used when the vehicle is being powered by the motor. In either or both situations, the method may include any or all of the optional features set out above. It is also envisaged that pulse loads may be applied periodically.

There are several reasons for this. Firstly the periodically varying current approach, especially when repeated for a plurality of currents each of different frequency, is time consuming. This approach may not therefore be best suited for use when the vehicle is in motion, during which time the operating mode of the battery may change, thereby affecting the low-frequency response.

In addition, the pulse load variation also suffers from certain drawbacks, such as not necessarily providing for low or high (depending on the inductance) frequency response, a reduced signal to noise ratio and the assumption that the battery operates as a linear system. Accordingly, in some embodiments, both arrangements may be used. For example, the approach in which the current is cyclically varied may be used when the vehicle is stationary and/or cruising with substantially constant speed; and the approach in which a pulse load variation is used may be used when the vehicle is accelerating or decelerating.

### [Fitting to a Model]

In step (d), the information indicative of the correlation may be stored information. Step (d) may comprise comparing the calculated complex impedance and the frequency of the varying current against information indicative of a correlation between (i) those quantities and (ii) the information indicative of the condition of the at least one cell. The information indicative of the condition of the at least one cell may comprise information indicative of, for example, the state of life of the cell (overall complex impedance being indicative of state of life), the state of charge of the cell and/or degradation rate of the cell. The information indicative of the state of charge of the cell may be information indicative of the charge transfer processes occurring at electrode-electrolyte interfaces. The information indicative of the degradation rate may be information indicative of the resistance of the solid electrolyte interface (SEI) of the cell. The information indicative of degradation may comprise information indicative of the high frequency intercept on the complex impedance spectrum (Nyquist plot). This is especially useful with li-polymer cells—their “bulk” resistance (indicated by HF intercept) can change drastically over cycles.

The information indicative of a correlation between the complex impedance and the condition of the at least one cell may be information indicative of a correlation between a component of an equivalent circuit, the equivalent circuit being obtained by the application of a mathematical algorithm to empirical data relating to the cell. The empirical data may comprise EIS data at different states of charge.

As temperature can affect impedance response, it is also envisaged that temperature of the at least one cell may be sensed and used to correct for the affect of temperature. Accordingly, the information which may be stored information may also take account of cell temperature. For example, that information may be at least partly a function of temperature, or there may be separate sets of information, each for a respective temperature.

### [Other Aspects]

According to a second aspect of this invention, there is provided processing and control means for a power converter, the processing and control means programmed and operable to control the power converter in accordance with the method defined above.

The processing and control means may comprise current directing means for causing the varying current drawn from the battery to flow through the battery substantially without flowing to the load. The current directing means may comprise one or more H-bridge circuits.

The processing and control means may be further arranged to receive information from sensing means indicative of the quantities sensed in the sensing steps defined hereinabove.

The processing and control means may be further arranged to carry out step (d).

According to a third aspect of this invention, there is provided a control system comprising the processing and control means and further comprising the sensing means.

According to a fourth aspect of this invention, there is provided a computer program having code portions executable by the processing and control means to cause the processing and control means to operate as define hereinabove.

According to a fifth aspect of this invention, there is provided a record carrier comprising thereon or therein a record of the code portions. The record carrier may comprise an optical storage medium, such as, for example, a computer-readable disk such as, for example, a CD-ROM or DVD-ROM. The record carrier may comprise a solid-state storage medium such as, for example, volatile memory and/or non-volatile memory; it may comprise, for example, an EPROM, and EEPROM and/or flash memory. The record carrier may be a signal; it may be a wireless signal.

According to a sixth aspect of this invention, there is provided a vehicle comprising a control system as defined hereinabove.

According to a seventh aspect of this invention, there is provided a batter-powered device comprising a control system as defined hereinabove. Such a device may comprise and uninterruptible power supply (UPS).

### BRIEF DESCRIPTION OF DRAWINGS

Specific embodiments of the invention are described below by way of example only and with reference to the accompanying drawings, in which:

FIG. 1 is a schematic view of a vehicle having an electric drive-train;

FIG. 2 is a schematic circuit diagram of components of the drive-train;

FIG. 3 is flow diagram of a method executed by those components;

FIG. 4 is a schematic circuit diagram of components of a first modified drive-train;

FIG. 5 is an empirical plot of complex impedance at various states of charge;

FIG. 6 shows in schematic form an equivalent circuit;

FIGS. 7a, 7b and 7c show the relationship between components of the equivalent circuit and state of charge; and

FIG. 8 is a schematic circuit diagram of components of a second modified drive-train.

### SPECIFIC DESCRIPTION OF CERTAIN EXAMPLE EMBODIMENTS

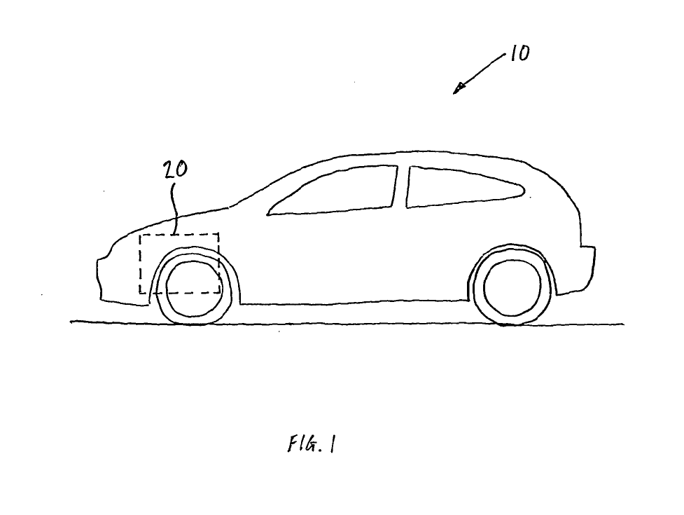

FIG. 1 shows a vehicle 10. The vehicle 10 is an electric vehicle of the type having an electric drive-train 20. The drive-train 20 is such that the vehicle 10 is powered solely by an electrical motor drawing electrical power from a rechargeable battery (neither the electric motor nor the rechargeable battery are shown in FIG. 1). Although in the present embodiment, the vehicle 10 is powered solely by stored electric power, it is envisaged that, in other embodiments, the vehicle 10 may be a hybrid electric vehicle in which an internal combustion engine is used at least partly to power the vehicle. In the present embodiment, the hybrid vehicle is one having a “parallel” drive-train configuration in which both the engine and motor can be used, separately or together, to provide mechanical drive to the wheels. However, in other embodiments, a “series” configuration may be used in which the engine is operated to drive a generator for supplying electrical power to a motor that is coupled to provide mechanical drive to the wheels. In other embodiments, a combination of both configurations may be used.

As will become clear from the following description, at least certain components of the drive-train in this embodiment are arranged and operable to provide an improved arrangement for monitoring the condition of the rechargeable battery.

FIG. 2 shows certain components of the electric drive-train 20 in more detail. With continued reference to FIG. 2, the electric drive-train 20 is generally made up of a rechargeable lithium-ion battery 30, a motor controller 40 and an electric motor 50. Although a lithium-ion battery is used in this embodiment, it is envisaged that other battery chemistries may be used in other embodiments. The battery 30 is connected across inputs of an inverter 42 of the motor controller 40; and the motor is connected across outputs of the inverter 42 of the motor controller 40. The motor controller 40 additionally includes control electronics 44 that are arranged and operable under the control of instructions stored in the control electronics to control operation of the inverter 42 and thereby control operation of the electric motor 50. The control electronics 42 includes processing means in the form of a microprocessor (not shown) and storage means in the form of solid-state memory (not shown). The processing means is arranged to execute instructions stored in the memory to control operation of the control electronics, and hence of the inverter 42 and motor 50.

Connected between the battery 30 and the input of the inverter 42 of the motor controller 40 is a capacitance 35. The skilled person will understand that such a capacitance is sometimes provided in the drive-trains of electric vehicles for the purpose of supplying electric power rapidly and for short duration to the inverter 42 and hence the motor 50 for short periods of, for example, rapid acceleration. The capacitor can then be recharged during periods of lower demand. A capacitance is also useful in providing a path for the ripple current that results from high frequency switching of the inverter drive.

The electric drive-train 20 further includes sensing means 60 in the form of a digital signal processor 61, that includes a respective analogue-to-digital converter (not shown) for each input channel, connected via differential instrumentation amplifiers 62 to sense the voltage across and current through each cell 32 of the battery 30 (although current sensing is not shown in the drawings for simplicity of illustration). In this exemplary embodiment, the battery 30 is shown with just four cells for simplicity of description. The battery 30 would, in reality, contain many more cells arranged in parallel and/or series with each other. The arrangement of the differential instrumentation amplifiers 62 and the wiring in FIG. 2 is schematic, again, for simplicity of description. The skilled addressee will understand how such an arrangement would be implemented in practice in order to sense the voltage across and current through each cell 32 of the battery 30. The control electronics 44 of the motor controller 40 are connected to receive various inputs for use in controlling the inverter 42 and hence the motor 50. Of these inputs, only two are necessary for understanding the present embodiment and so only these are shown in FIG. 2. These are an input 63 from the digital signal processor 61 and an input 64 from the driver indicative of required motor speed (it will be understood, however, that, strictly speaking, the motor controller 40 may receive only a single input in the form of a current or torque requirement, with the modulation from the DSP being added to the current/torque requirement). It will be understood that this last input 64 may be provided by, for example, an accelerator pedal operable by the driver.

At least certain of the components described above are to be found in the drive-trains of existing electric and hybrid vehicles. At least the battery 30, the capacitance 35, the motor controller 40 and the motor 50 are conventional.

The operation of these components, and in particular the instructions stored in the control electronics 44 that determine the operation thereof are, however, not conventional. This operation will now be described.

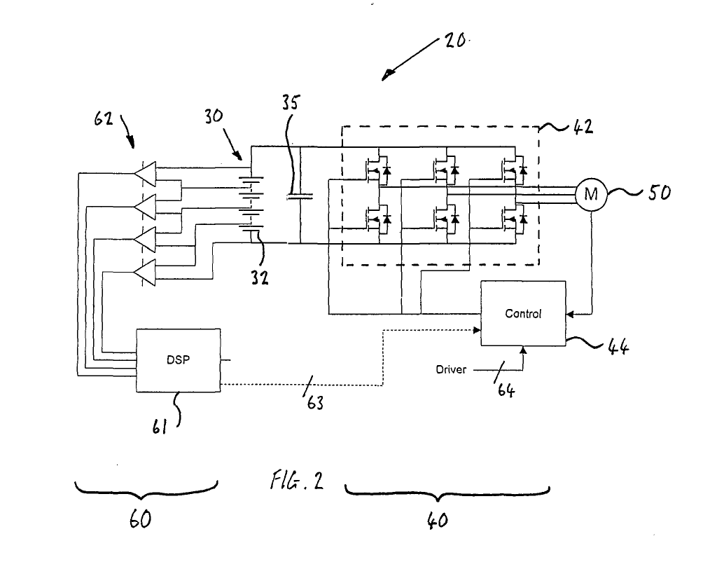

Operation of the drive-train 20 is generally the same as that for existing electric vehicles except in relation to the way in which the drive-train 20 monitors the condition of the battery 30. In the present embodiments, the memory of the control electronics 44 includes a record of instructions for carrying out a battery monitoring routine 100. This routine amounts to an example method that embodies the invention. The battery monitoring routine will now be described with reference to FIG. 3.

### [Frequency-Sweep Method:]

With continued reference to FIG. 3, the battery monitoring routine 100 starts at step 110 and then proceeds to step 120 in which the control electronics 44 control the inverter 42 to create a small sinusoidal variation in the input impedance of the inverter 44 as seen by the battery 30. This small variation in the input impedance of the inverter 44 causes a small sinusoidal variation in the current drawn by the inverter 42 from the battery 30 that is used for powering the motor 50. In other words, the inverter is controlled to introduce a small sinusoidal AC ripple current into the current drawn from the battery 30 for powering the motor 50. Whilst the inverter is being controlled in this way, the routine progresses to step 130 in which the digital signal processor 61 senses the voltage across and current through each cell 32 of the battery 30. Information indicative of the voltage across and current through each cell 32 is then communicated through input 63 to the control electronics 44.

The routine then progresses to step 140 in which the microprocessor of the control electronics 44 calculates the complex impedance of each cell from the sensed voltage across and sensed current through each cell.

The method then proceeds to step 150 in which the routine returns and repeats steps 120 to 140, but with the inverter 42 being controlled to vary its input impedance, at a frequency different from that which it was varied previously. This loop is repeated, each time with a different frequency of impedance variation, between a predetermined range of frequencies and at a predetermined number of different frequencies within that range. In the present embodiment it is envisaged that this range should be between approximately 10 mHz and 10 kHz and it is envisaged that the number of different frequencies would be approximately 20. In other embodiments, these steps may be repeated for more or fewer different frequencies. Once steps 120 to 140 have been repeated for each of the predetermined frequencies, the routine proceeds to step 160.

At step 160, the processing means compares the calculated complex impedance of each cell, together with the frequency of the variation in input impedance of the inverter 42 used to generate that calculation, with a record in the memory of a predetermined correlation between those two quantities and the state of charge and battery degradation rate. For example, it has been found that the frequency response of the complex impedance of a commercial lithium-ion battery between 10 Hz and 100 Hz corresponds to the impedance of the solid electrolyte interface (SEI) of the battery and so provides information about the rate of degradation of the battery. It has also been found that the frequency response between 10 mHz and 10 Hz corresponds to the charge transfer processes occurring at the electrode-electrolyte interfaces and so provides and indication as to the state of charge of the battery. Accordingly, comparing the measured frequency response with stored frequency responses allows deductions to be made as to the state of charge of each cell and the rate of degradation of each cell. It is envisaged that the stored frequency responses be in the form of several look-up tables that also take account of other factors, such as by having look-up tables for each of various different operating temperatures and/or stages in the life cycle of the battery and/or different discharge current rates. Alternatively, the measured frequency response may be compared with a calculated frequency response, calculated using an algorithm that takes accounts of these various factors.

The routine then proceeds to step 170 in which these deductions are made available by the processing means of the control electronics to other routines being executed thereby, and also to other components for use in managing the battery 30 effectively.

The battery monitoring routine 100 then ends at step 180.

In this embodiment, it is envisaged that the battery monitoring routine 100 be performed periodically during normal operation of the vehicle 10 in order to provide information as to the condition of the battery 30 during operation of the vehicle 10 and so allow for effective management of the battery 30. It is conceivable, however, at least in certain circumstances, that controlling the inverter 42 such that its input impedance is varied as described above would affect the performance of the vehicle 10 in an undesirable manner. For example, it is conceivable that applying a ripple current to the normal current drawn from the battery 30 may result in torque ripple at the motor 50 and resulting vibration and acoustic noise in the passenger cabin of the vehicle 10. In order to avoid this, it is envisaged that, at least in some embodiments, the battery management routine 100 described above be carried out only when the vehicle is at rest. In such circumstances, the ripple current would be substantially the only current drawn from the battery 30. In other embodiments, however, and as will already have been understood, it is envisaged that the battery monitoring routine 100 be carried out when the vehicle is in motion under the power of the motor 50.

As the battery monitoring routine 100 described above with reference to FIG. 3 involves varying the input impedance of the inverter 42 at each of a plurality of different frequencies within a range of frequencies, this can be referred to as a “sinusoidal frequency-sweep” method for monitoring the condition of the battery 30. An alternative method will now be described below which does not necessarily rely on controlling the input impedance of the inverter 42 to draw a ripple current from the battery 30, but may instead rely on making use of the variation in the input impedance of the controller brought about for the purposes of accelerating or decelerating the motor 50 in response to changing road conditions or a change in input from the vehicle driver. This alternative method forms part of a second embodiment which will now be described in detail.

### [Pulse Method:]

In the second detailed embodiment, which is not illustrated, the processor of the control electronics 44 receives from the digital signal processor 61 information indicative of the voltage across and current through each cell 32 when the inverter 42 has been controlled such that its input impedance varies to impose a square pulse load current variation on the battery 30. Such a square pulse load variation would be imposed on the battery when, for example, the control electronics 44 receives a signal at input 64 from the driver to the effect that rapid acceleration or deceleration of the motor is required. The microprocessor of the control electronics 44 then, as before, calculates the step-response complex impedance of each cell 32. Again, this can be compared with values stored in the memory to make deductions about the condition of the battery 30, including the SOC. These deductions can then be made available as before. As this approach relies on a non-sinusoidal pulse in load that arises from normal operation of the vehicle 10, this can be termed a “pulse method”. This pulse method is based on the premise that a narrow pulse contains, in principle, infinite different frequencies and so it is theoretically possible to obtain all the information needed from one pulse response, if an assumption that the system responds linearly is justified. In practice, however, it may not be possible to obtain all the information that is needed in this way and so, as noted below, in at least some embodiments both the frequency sweep method and the pulse method may be used.

A square pulse is used in the arrangement described above. In other embodiments, however, the pulse load need not be square. Instead, the pulse could, conceivably, be any non-periodic waveform. It may, for example, be a step, impulse, ramp and so on. A square pulse may, however, be preferred as it contains the “most” frequencies. The amount of frequency information that can be extracted from other forms of pulse will vary with the particular form of the pulse.

There are certain advantage and disadvantages of the sinusoidal frequency sweep method and the pulse method. The frequency sweep method provides a comprehensive and accurate determination of the condition of the battery. However, it is a time-consuming method to perform and, as noted above, it may impact negatively on certain aspects of vehicle performance. The pulse method is much quicker to perform than the frequency sweep method (it can be performed during a single pulse load event, or continuously during normal driving) and, as it can be performed using load variations dictated by normal operation of the vehicle, tends not to affect vehicle performance adversely. That said, the pulse method suffers from the drawbacks of potentially more complicated signal processing and a trade-off between signal-to-noise ratio and linearity of response.

### [Both May be Used:]

As a result of these various advantages and disadvantages, it is envisaged that, in certain embodiments, both methods may be used. For example, the pulse method may be used during acceleration or deceleration; and the frequency sweep method may be used to perform a full analysis when the vehicle is at rest (for example, at a junction) or when unused and recharging. In this way, best use may be made of the advantages of each method and at least some of the disadvantages avoided or mitigated.

[First Variant with H-Bridge:]

In a third embodiment described now in detail, and shown in FIG. 4, a modified electric drive-train 200 is provided. With continued reference to FIG. 4, the modified drive train includes the same components as the drive-train 20 of the first embodiment described above with reference to FIG. 2. The same reference numerals are therefore used in this present embodiment to identify those common components. The present embodiment differs, however, in that the modified drive-train 200 includes additional circuitry in the form of an H-bridge 210 connected across the battery 30 (it is envisaged that one such H-bridge be provided for each battery pack). The H-bridge 210 is shown in FIG. 4 connected to be controlled by the digital signal processor. In other embodiments, however, it is envisaged that the H-bridge would be connected for control by the control electronics 44 under operation of instructions executed by the microprocessor. Whichever of these two approaches is used for controlling the H-bridge 210, the H-bridge 210 is controlled to apply a load to the battery 30 that, in the frequency-sweep method (or pulse method) described with reference to FIG. 3, is applied by the inverter 42 of the motor controller 40. The remainder of the method is performed in the same way. In the present embodiment, the H-bride 210 is arranged to provide a periodic sawtooth variation.

The reason for providing a dedicated H-bridge 210 to apply the varying load and so draw the ripple current is to avoid the aforementioned problems that may be experienced when using the inverter 42 of the motor controller 40 for this purpose: torque ripple in the motor and associated vibration and acoustic noise. Whilst this is not as elegant a solution as using the inverter 42, the additional hardware of the H-bridge 210 only needs to handle the ripple current, rather than the current used to drive the motor 50, and so can be simple, inexpensive, small and light.

In other embodiments, it is envisaged that the pulse method may be used together with the frequency-sweep method in the modified drive-train 200 in a manner similar to that described above.

[Second Variant with H-Bridge]

FIG. 8 shows a fourth embodiment 300 that is a variation of the embodiment shown in and described with reference to FIG. 2. The present embodiment retains all of the components of the FIG. 2 embodiment. FIG. 8 therefore shows the inverter 42, capacitor 35 and battery 30 of the FIG. 2 embodiment. The control electronics 44 and the sensing means 60 are emitted from FIG. 8 for simplicity of explanation, but are also be retained in this embodiment. The present embodiment differs from the FIG. 2 embodiment by including dedicated perturbation circuitry 310, that is, another H-bridge of different design to that of the third embodiment. This dedicated circuitry 310 takes the form of a ‘synchronous converter’ which can move charge either from the battery 30 to the capacitor C₂ or vice versa. The way it functions is that the capacitor C₂ is first pre-charged to the same voltage as the battery (through the diodes). Then the converter is controlled so as to boost the voltage on C₂ to a higher voltage than the battery (say around double). Then a sinusoidal bi-polar current fluctuation through the battery can be achieved by adjusting the duty cycle of the converter and monitoring and controlling the battery current which flows through the inductor.

The perturbation circuitry 310, that is, the H-bridge of the present embodiment, differs from that of the third embodiment by being arranged and operable to provide a periodic waveform of any shape, including a sinusoid.

It is envisaged that this embodiment may be operated in accordance with any of the “active” approaches to perturbation described herein, and with any of the described techniques for detecting the frequency response and obtaining information as to the SOC of the battery therefrom.

In still other embodiments, one or both of the following methods of perturbing the current drawn from the battery may be used. The may be used together with, or in substitution for, the frequency-sweep method and/or the pulse method. Where apparent to the skilled addressee from the present disclosure as being workable, they may be used with either of the H-bridge arrangements described herein.

### [Multi-Frequency Method:]

The first of these two alternative methods is a “multi-frequency method”. This is similar to the frequency-sweep method described above, but differs in that the inverter 42 is controlled such that an AC ripple current is introduced in the current drawn from the battery 30 in which all of the various frequencies used in the frequency-sweep method are present at the same time. Thus, one of the drawbacks identified with the frequency-sweep method—that of the time taken for it to be carried out—is addressed.

In carrying out this multi-frequency method, it is preferred in this embodiment to select frequencies for the AC ripple current that do not have overlapping harmonics in order to avoid problems in measuring the frequency response of the battery. Analysis is performed by taking the Fourier transform of the response and selecting frequencies of interest.

### [Pseudo-Random Binary Sequence:]

The second of these two alternative methods is one in which a pseudo-random binary sequence is used. In the frequency domain, a pseudo-random binary sequence, such as a maximal length sequence, looks approximately like white noise. Two of the advantages of this approach are that it is relatively easy to generate the signal and perturb the system in this manner (because the perturbation hardware and software is quite simple) and, because of the multiple frequency content, it may be a faster method than the frequency-sweep method described above, depending on how much spectral averaging is required.

### [Passive Approach:]

With the exception of some instances of the “pulse method”, each of the methods described above relies on active perturbation of the current drawn from the battery 30 by controlling the inverter 42 (or an additional circuit such as one of the H-bridges described herein) deliberately to give rise to that perturbation. These can therefore be considered as “active” approaches. (Although, as noted above, it is envisaged that, in some circumstances the “pulse method” may be used with normal acceleration events of the vehicle.) It is, however, also envisaged that embodiments may additionally, or in substitution, make use of a “passive approach”. In such as approach, the inverter 42 is not controlled specifically to perturb the current drawn from the battery 30. Instead, this approach makes use of noise and other spectral content already present in the system as a result of its normal operation. In a passive approach, the analysis of the frequency response is more challenging and so, for reasons that will become clear, the “Stochastic approach” described below is preferred.

### [Detecting the Measured Frequency Response:]

As will be understood from the foregoing description of certain embodiments, a number or options exist for perturbing the battery 30. A number of options also exist for detecting the measured frequency response, with some of these being more suited to certain methods of perturbation. What follows is a description of various methods of detecting the measured frequency response.

Firstly, the skilled reader is reminded that we can think of what is being measured as the impedance of the battery Z(s)=v(s)/i(s), in the frequency domain, by measuring both current and voltage. The ‘driving’ perturbation is the current drawn, i(s). It could also be the voltage, but current is easiest to control. This perturbation may, as set out above, be produced actively or passively.

### [Phase Detector]

In the case of single frequency perturbation, such as in the “frequency-sweep” method, to detection of magnitude is achieved by dividing the RMS voltage perturbation by the RMS current perturbation. Detection of phase can be accomplished using a ‘phase detector’. This involves multiplying the measured signal by both in-phase and quadrature reference sinusoids at the same frequency as the driving perturbation. The results are then low pass filtered. This gives two signals, proportional respectively to the cosine and sine of the phase difference between the measured and reference signals. This is done for both current, and voltage, respectively, they are then subtracted to obtain the phase of the impedance.

### [Fourier Transforms]

If one wishes to detect more than one frequency concurrently, such as in the “multi-frequency” method, the method using a pseudo-random binary sequence, or in the “pulse” method, then it is possible to take Fourier transforms of the voltage and current. However in order for this to work, a good signal-to-noise ratio is required between ‘desired’ frequencies (those driven by the perturbation system), and ‘noisy’ frequencies (where undesirable noise is added to the measured voltage) which render the impedance results meaningless. If the system is being actively driven at set frequencies, then it can be arranged that these are spaced at regular intervals such that Fourier transforms can be taken at these frequencies only. However, it is preferable to take the stochastic approach described below.

### [Stochastic Approach]

Instead of the above approaches, it is possible to use a statistical approach to measure the impedance spectrum. A non-deterministic perturbation is applied (or already present, such as in the “passive” approach described above and therefore doesn't need to be actively applied), having random characteristics and a broad spectrum of frequencies present. A non-deterministic signal cannot be defined as some explicit function of time (such as y=sin ωt), but rather by its statistical properties.

In short, it is found that the complex impedance is given by:

$$Z ( ω ) = \frac{{Φ}_{iv}}{{Φ}_{ii}}$$

where Φᵢᵥ is the cross-spectral density between current and voltage (this is a complex number), and Φᵢᵢ is the power-spectral density of the current. The cross-spectrum is obtained by taking the Fourier transform of the cross-correlation of the current with the voltage, and the power spectrum is from the Fourier transform of the auto-correlation of the current.

In the embodiments described herein, it is envisaged that:
(1) Spectral averaging be employed to improve the results
(2) The coherence function be used to estimate the quality of the signal, by estimating the distortion of the output (voltage) caused by unwanted noise at the output. This can be used to only accept frequencies where there is a good correlation between current and voltage.

### [Fitting the Measured Frequency Response to a Model]

Once the frequency response has been ascertained as set out above, that response is used to determine the state of charge (SOC) of the battery. An approach for doing this, that it is envisaged be used with the methods described hereinabove, will now be described.

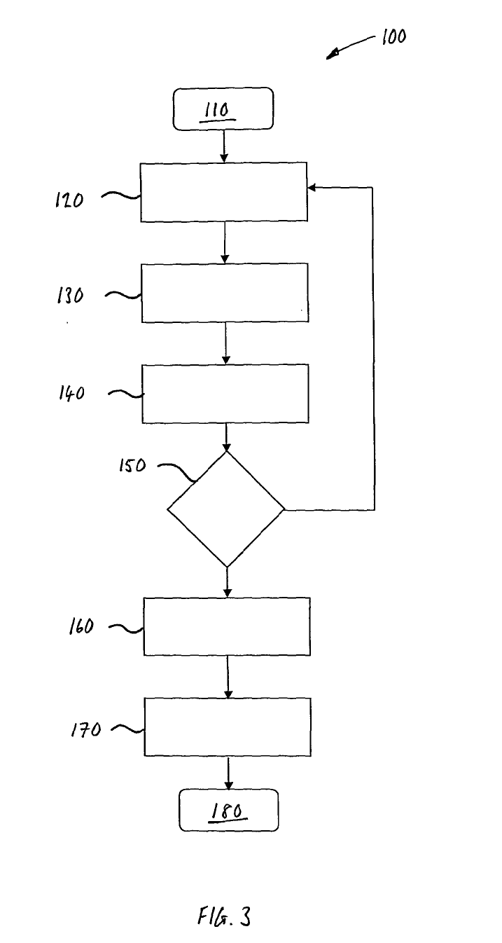

An example of the variation of battery impedance response at various SOCs is shown in FIG. 5. As can be seen, every SOC can be characterised by a unique impedance response (which is also a function of temperature and cycle life). In order to extract valuable information from the impedance response as to battery SOC and SOH, a mathematical fitting algorithm is applied based either on an empirical or physical model. In the present approach, an empirical model for impedance response based on an equivalent circuit of capacitors, inductors, resistors, constant, diffusion and other phase elements is used. As shown in FIG. 6, in this example, the equivalent circuit comprises one inductor, two constant phase elements, three resistors and generalised Warburg diffusion element. In this example, the impedance is therefore given by:

$${Z}_{total} = {R}_{H F} + j ω {L}_{0} + \frac{{R}_{1}}{1 + {R}_{1} {{T}_{CPE 1} ( j ω )}^{{F}_{CPE 1 }}} + \frac{{R}_{2}}{1 + {R}_{2} {{T}_{CPE 2} ( j ω )}^{{P}_{CPE 2}}} + {R}_{W} \frac{tanh ( {[ j ω {T}_{W} ]}^{{P}_{W}} )}{{( j ω {T}_{W} )}^{{P}_{W}}}$$

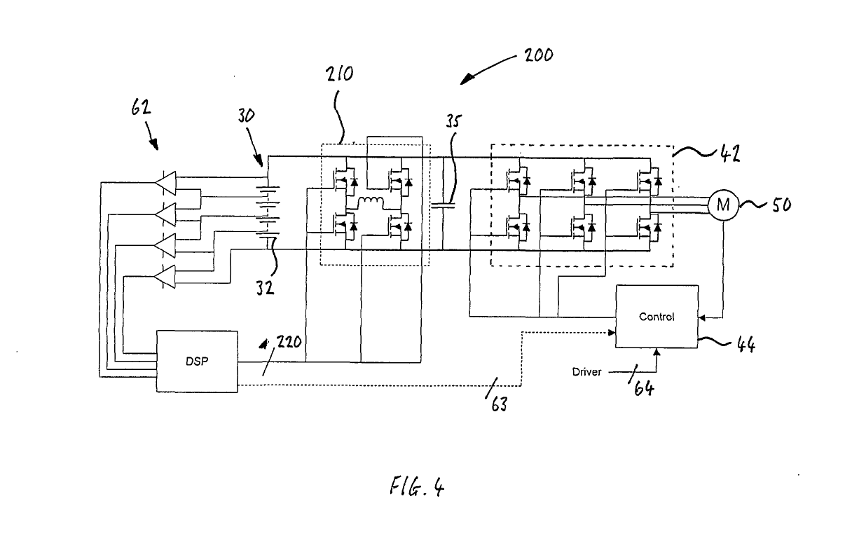

The application of an equivalent circuit model to fit an example battery impedance is response at different SOCs provides values of the circuit elements as a function of SOC. These relationships are shown in the graphs of FIGS. 7a, 7b and 7c. As shown in these graphs, the variation of different circuit elements can be an indicator of battery SOC. However, not every element can serve as a good indicator. In the present example, it can be seen that resistor elements R_{HF}, R₁ and R₂ are not very useful for determining battery SOC. The same is true of elements CPE-T₂, CPE-P₂, Warburg-P and Warburg-T. The elements CPE-T1, CPE-P1 and, to some extent, Warburg-R are however useful in determining SOC since these clearly exhibit either increasing or decreasing trend as a function of SOC.

In the present case, for the specific battery chemistry, manufacturer and specific battery series used (A123 Systems A26650M1A 3.3V 2.3Ah cell that utilises nanometric lithium iron phosphate cathode), it seems that only CPE-T1 has the most prominent correlation with SOC. This correlation would therefore be used. This correlation however might not be true for other batteries, such as lithium-ion battery implementing metal oxide cathodes. Thus, another correlation may have to be used. In any event, once we have a variation of a parameter with SOC has been identified, a lookup table is built which a enables a direct correlation between this parameter and SOC.

By way of further background, any battery system either having different electrochemistry or supposedly having the same electrochemistry but fabricated by different manufacturer or even fabricated by the same manufacturer but with slightly different composition or characteristics will have a unique frequency response spectrum. Prior to assembling the battery pack, individual cells should be tested to generate EIS data at different SOCs. Then a mathematical algorithm is run to fit experimental data with an appropriate equivalent circuit to extract numerical data for the circuit components. The next step is to construct plots of these data as a function of SOC and try to find the most suitable one (or more) in terms of their variation. The best parameters to use are those that change monotonically (either increasing or decreasing) with no abrupt discontinuities.

1. A method of monitoring the condition of at least one cell of a battery connected to a power converter to supply electrical power to an electrical load, the method including
the steps of:
a) controlling the power converter to vary the input impedance of the power converter so as to draw a varying current from the at least one cell;
b) sensing the voltage across the at least one cell and the current drawn therefrom in response to varying the impedance of the power converter;
c) calculating from the sensed voltage and current the complex impedance of the at least one cell; and
d) comparing the calculated complex impedance with information indicative of a correlation between (i) the complex impedance and (ii) information indicative of the condition of the at least one cell, to give an indication of the condition of the at least one cell.

2. The method according to claim 1, wherein the power converter is a motor controller and the load is an electric motor.

3. The method according to claim 2, wherein step (a) of the method comprises controlling an inverter of the motor controller to vary the input impedance of the inverter.

4. The method according to claim 1, wherein the power converter is a power converter for an electronic device, such as a portable electronic device, for example a mobile telephone, a portable computer.

5. The method according to claim 1, wherein step (a) comprises controlling the impedance to draw the varying current such that the varying current comprises a current for usefully powering the load.

6. The method according to claim 1, wherein step (a) comprises controlling the impedance to draw the varying current such that the varying current does not comprise a current for usefully powering the load.

7. The method according to claim 1, wherein the varying current is a
cyclically varying current, such as a sinusoidal alternating current.

8. The method according to claim 7, wherein the information indicative of the condition of the at least one cell comprises information indicative of, for example, state of charge of the cell and/or degradation rate of the cell; the information indicative of the state of charge of the cell optionally being information indicative of the charge transfer processes occurring at electrode-electrolyte interfaces; the information indicative of the degradation rate optionally being information indicative of the resistance of the solid electrolyte interface (SEI) of the cell.

9. The method according to claim 1, and further including carrying out the steps with a varying current of a first frequency and then repeating those steps with a varying current of a different frequency.

10. The method according to claim 9, wherein the steps are repeated plural times, each time with a varying current of a different respective frequency.

11. The method according to claim 1, wherein step (a) comprises controlling the power converter to vary the impedance such that the varying current is made up of a plurality of different frequencies simultaneously.

12. The method according to claim 1, wherein step (a) comprises controlling the power converter to vary the impedance such that a pulse load variation is applied to the at least one cell.

13. The method according to claim 1 and comprising controlling the power converter to draw a cyclically varying current and also controlling the power converter to apply a pulse load variation.

14. The method according to claim 1, wherein step (a) comprises controlling the power converter to vary the impedance such that the varying current is takes the form of a pseudo-random binary sequence, such as a maximal length sequence.

15. The method according to claim 1, wherein the voltage and current sensed in step (b) and used to calculate the complex impedance calculated in step (d) are noise and/or other spectral content present as a result of normal operation

16. Processing and control means for a power converter, the processing and control means programmed and operable to control a power converter in accordance with a method according to claim 1.

17. Processing and control means according to claim 16 and further arranged to receive information from sensing means indicative of the quantities sensed in sensing the voltage across the at least one cell.

18. A control system comprising processing and control means according to claim 17 and further comprising the sensing means.

19. A computer program having code portions executable by the processing and control means to cause the processing and control means to operate as defined in claim 16.

20. A record carrier comprising thereon or therein a record of code portions defined in claim 17.

21. A vehicle comprising a control system according to claim 18.

22. A battery-powered device comprising a control system according to claim 18.
